(19) United States
(12) Patent Application Publication
(10) Pub. No.: US 2019/0262950 A1
(43) Pub. Date: Aug. 29, 2019

(54) FLUX-CORED WIRE FOR GAS SHIELDED ARC WELDING

(71) Applicant: Kabushiki Kaisha Kobe Seiko Sho (Kobe Steel, Ltd.), Kobe-shi (JP)

(72) Inventors: Kazuki SAKAKIYAMA, Fujisawa-shi (JP); Kazuyuki KIKUCHI, Fujisawa-shi (JP)

(73) Assignee: Kabushiki Kaisha Kobe Seiko Sho (Kobe Steel, Ltd.), Kobe-shi (JP)

(21) Appl. No.: 16/239,601

(22) Filed: Jan. 4, 2019

(30) Foreign Application Priority Data
Feb. 27, 2018 (JP) 2018-032841

(51) Int. Cl. B23K 35/02; B23K 35/30; B23K 35/36; B23K 35/368

(52) U.S. Cl. CPC B23K 35/0266; B23K 35/3073; B23K 35/3602; B23K 9/16; B23K 35/3608; B23K 35/361; B23K 35/368

(57) ABSTRACT

A flux-cored wire for gas shielded arc welding is provided which affords excellent welding workability for high heat input welding and enables weld metal having good mechanical properties to be obtained. The flux-cored wire for gas shielded arc welding includes C, Mn, Si, elemental Ti, elemental Al, Fe, ZrO₂, TiO₂, and NaF, each within a predetermined range relative to the total mass of the wire. In the flux-cored wire, 1≤[ZrO₂]/[NaF]≤50 is satisfied, where [ZrO₂] is the ZrO₂ content, and [NaF] is the NaF content.

### BACKGROUND OF THE INVENTION

### 1. Field of the Invention

The present invention relates to a flux-cored wire for gas shielded arc welding.

### 2. Description of the Related Art

To date, gas shielded arc welding with a flux-cored wire has been employed in a variety of fields to perform welding operations with high efficiency. For example, Japanese Patent No. 2614967 discloses a metallic flux-cored wire for gas shielded arc welding. The metallic flux-cored wire produces reduced fumes while not compromising the high deposition rate, which is an advantage of a metallic flux-cored wire, nor compromising welding workability.

### SUMMARY OF THE INVENTION

The technology of Japanese Patent No. 2614967, however, does not address maintaining excellent welding workability, that is, high arc stability and a small amount of spatter generated, in high heat input welding with a welding heat input of, for example, 30 kJ/cm or greater, while obtaining weld metal having good mechanical properties. That is, achieving both of these is not realized by the technology of Japanese Patent No. 2614967.

Accordingly, it is an object of the present invention to provide a flux-cored wire for gas shielded arc welding, the flux-cored wire affording excellent welding workability for high heat input welding and ensuring that the resulting weld metal has good mechanical properties.

According to one aspect of the present invention, a flux-cored wire for gas shielded arc welding includes a steel sheath filled with a flux. The flux-cored wire for gas shielded arc welding includes, relative to the total mass of the wire, C: 0.01 mass % or greater and 0.10 mass % or less, Mn: 1.5 mass % or greater and 4.0 mass % or less, Si: 0.1 mass % or greater and 2.5 mass % or less, elemental Ti: 0.01 mass % or greater and 1.00 mass % or less, elemental Al: 0.01 mass % or greater and 1.00 mass % or less, Fe: 90 mass % or greater, ZrO₂: 0.01 mass % or greater and 1.00 mass % or less, TiO₂: 0.01 mass % or greater and 0.50 mass % or less, and NaF: 0.01 mass % or greater and 0.50 mass % or less. In the flux-cored wire for gas shielded arc welding, 1≤[ZrO₂]/[NaF]≤50 is satisfied, where [ZrO₂] is the ZrO₂ content, and [NaF] is the NaF content.

The flux-cored wire for gas shielded arc welding may further include, relative to the total mass of the wire, Al₂O₃: 0.01 mass % or greater and 0.50 mass % or less. The flux-cored wire for gas shielded arc welding may further include, relative to the total mass of the wire, at least one of K₂O, in terms of K: 0.01 mass % or greater and 0.50 mass % or less and Na₂O, in terms of Na: 0.01 mass % or greater and 0.50 mass % or less.

The flux-cored wire for gas shielded arc welding according to one aspect of the present invention affords excellent welding workability for high heat input welding and ensures that the resulting weld metal has good mechanical properties.

### DESCRIPTION OF THE PREFERRED EMBODIMENTS

An embodiment (present embodiment) of the present invention will be described in detail below. Note that the present invention is not limited to the embodiment described below, and that the embodiment may be modified and implemented in any manner that does not depart from the scope of the present invention.

According to the present embodiment, a flux-cored wire for gas shielded arc welding (hereinafter also simply referred to as “flux-cored wire” or “wire”) includes, relative to the total mass of the wire, C: 0.01 mass % or greater and 0.10 mass % or less, Mn: 1.5 mass % or greater and 4.0 mass % or less, Si: 0.1 mass % or greater and 2.5 mass % or less, elemental Ti: 0.01 mass % or greater and 1.00 mass % or less, elemental Al: 0.01 mass % or greater and 1.00 mass % or less, Fe: 90 mass % or greater, ZrO₂: 0.01 mass % or greater and 1.00 mass % or less, TiO₂: 0.01 mass % or greater and 0.50 mass % or less, and NaF: 0.01 mass % or greater and 0.50 mass % or less. In the flux-cored wire, 1≤[ZrO₂]/[NaF]≤50 is satisfied, where [ZrO₂] is the ZrO₂ content, and [NaF] is the NaF content. Furthermore, the flux-cored wire according to the present embodiment is a metallic flux-cored wire. Here, the metallic flux-cored wire is a flux-cored wire in which the flux is primarily made of one or more metal components and in which one or more oxide components (slag-forming components) are present in an amount, for example, not greater than 3 mass % relative to the total mass of the wire. The oxide component is present preferably in an amount not greater than 2 mass % and more preferably not greater than 1 mass %.

The flux-cored wire of the present embodiment is a flux-cored wire including a steel sheath (hoop) filled with a flux. Specifically, the flux-cored wire according to the present embodiment is formed of a steel sheath having a tubular shape and a flux filling the interior (inside) of the sheath. The flux-cored wire may be of the seamless type, with no seam in the sheath, or of the seamed type, with a seam in the sheath. The flux-cored wire may or may not include a coating or the like, for example, a Cu coating, provided on the surface of the wire (exterior of the sheath).

The wire diameter (diameter) of the flux-cored wire according to the present embodiment is not particularly limited, but, from the standpoint of wire feeding stability, the wire diameter is preferably 1.2 to 4.0 mm and more preferably 1.2 to 2.4 mm.

Further, in the flux-cored wire according to the present embodiment, the content of each of the components conforms to a predetermined content, relative to the total mass of the wire, and, for the contents of some of the components, a predetermined relationship is satisfied. In the following description, reasons for the limitation on the content of each of the components of the flux-cored wire according to the present embodiment will be described.

In the following description, the amount of each of the components in the flux-cored wire is defined as the content relative to the total mass of the wire (sum of the mass of the steel sheath and the mass of the flux within the sheath) unless otherwise indicated.

In the present embodiment, Ti oxide is included, and TiO₂ is a representative example of the Ti oxide. The Ti oxide may include one or more other Ti oxides. In the present embodiment, the term “TiO₂” refers to TiO₂ and other Ti oxides. The same applies to other oxide components. For example, the term “ZrO₂” refers to ZrO₂ and other Zr oxides, and the term “Al₂O₃” refers to Al₂O₃ and other Al oxides.

### C: 0.01 Mass % or Greater and 0.10 Mass % or Less

C is a component that produces an effect of improving the hardenability and toughness of the weld metal. If the C content is less than 0.01 mass %, however, the weld metal is not sufficiently hardened and, in the case of high heat input welding, does not have sufficient toughness. Accordingly, the C content is not less than 0.01 mass % and preferably not less than 0.02 mass %. On the other hand, if the C content is greater than 0.10 mass %, the arc strength increases, which increases the amount of spatter generated. Accordingly, the C content is not greater than 0.10 mass %, preferably not greater than 0.07 mass %, and particularly preferably not greater than 0.05 mass %.

### Mn: 1.5 Mass % or Greater and 4.0 Mass % or Less

Mn is a component that produces an effect of improving the hardenability and toughness of the weld metal. If the Mn content is less than 1.5 mass %, however, the weld metal is not sufficiently hardened, and as a result, the tensile strength of the weld metal is insufficient. Accordingly, the Mn content is not less than 1.5 mass % and preferably not less than 2.0 mass %. On the other hand, if the Mn content is greater than 4.0 mass %, an excessive amount of Mn is included in the weld metal, which results in an excessive increase in the tensile strength of the weld metal. Accordingly, the Mn content is not greater than 4.0 mass % and preferably not greater than 3.1 mass %. Here, Mn means pure elemental Mn, Mn included in alloys, and Mn components included in Mn oxides, such as MnO. Examples of the Mn source include powders of elemental Mn, powders of metals such as Fe—Mn and Fe—Si—Mn, and powders of alloys. In addition to these, examples may include Mn oxides.

### Si: 0.1 Mass % or Greater and 2.5 Mass % or Less

Si is a component that produces an effect of improving the hardenability and toughness of the weld metal and an effect of improving the shape of the bead. If the Si content is less than 0.1 mass %, however, the weld metal is not sufficiently hardened and, as a result, the tensile strength of the weld metal is insufficient in some cases. Accordingly, the Si content is not less than 0.1 mass % and preferably not less than 0.2 mass %. On the other hand, if the Si content is greater than 2.5 mass %, an excessive amount of Si is included in the weld metal, which results in, for example, an excessive increase in the tensile strength of the weld metal in some cases. Accordingly, the Si content is not greater than 2.5 mass % and preferably not greater than 1.4 mass %. Here, Si means pure elemental Si, Si included in alloys, and all Si components included in Si oxides, such as SiO₂.

It is preferable that the elemental Si content be 0.1 mass % or greater and 2.0 mass % or less. It is more preferable that the elemental Si content not be less than 0.2 mass %. It is more preferable that the elemental Si content not be greater than 0.8 mass %. Furthermore, it is preferable that the content of SiO₂ (in terms of Si) be 0.01 mass % or greater and 1.00 mass % or less. When the content of SiO₂ (in terms of Si) is within this range, arc stability is improved further, and the amount of spatter generated can be further reduced. It is more preferable that the content of SiO₂ (in terms of Si) not be less than 0.20 mass %. It is more preferable that the content of SiO₂ (in terms of Si) not be greater than 0.60 mass %

### Elemental Ti: 0.01 Mass % or Greater and 1.00 Mass % or Less

Elemental Ti is a component that produces an effect of improving the mechanical properties of the weld metal and arc stability. If the elemental Ti content is less than 0.01 mass %, however, the effect of improving arc stability is not produced, and therefore, under a high-current load, arc stability deteriorates, and the amount of spatter generated increases. Accordingly, the elemental Ti content is not less than 0.01 mass % and preferably not less than 0.10 mass %. On the other hand, if the elemental Ti content is greater than 1.00 mass %, an excessive amount of Ti is included in the weld metal, which results in an excessive increase in the tensile strength of the weld metal in the case of high heat input welding. Accordingly, the elemental Ti content is not greater than 1.00 mass % and preferably not greater than 0.50 mass %.

### Elemental Al: 0.01 Mass % or Greater and 1.00 Mass % or Less

Elemental Al is a component that produces an effect of improving the mechanical properties of the weld metal and arc stability. If the elemental Al content is less than 0.10 mass %, however, the effect of improving arc stability is not produced, and therefore, under a high-current load, arc stability deteriorates, and the amount of spatter generated increases. Accordingly, the elemental Al content is not less than 0.01 mass % and preferably not less than 0.05 mass %. On the other hand, if the elemental Al content is greater than 1.00 mass %, the component is included in the weld metal in an excessive amount, and therefore, sufficient toughness cannot be achieved in the case of high heat input welding. Accordingly, the elemental Al content is not greater than 1.00 mass % and preferably not greater than 0.40 mass %. Here, the “elemental Al content” is equal to the sum of the amount of the elemental metal and the amount of Al included in an alloy.

### Fe: 90 Mass % or Greater

Fe is a main component of the flux-cored wire. In view of the weld quantity and the relationship with the other components in the chemical composition, the Fe content is preferably not less than 90 mass % and more preferably not less than 92 mass %, relative to the total mass of the wire.

### ZrO₂: 0.01 Mass % or Greater and 1.00 Mass % or Less

ZrO₂ is a component that produces effects of improving arc stability and, by serving as a slag-forming agent, improving the shape of the bead of the weld metal. If the ZrO₂ content is less than 0.01 mass %, however, the effect of improving arc stability is not produced, and therefore, under a high-current load, arc stability deteriorates, and the amount of spatter generated increases. Accordingly, the ZrO₂ content is not less than 0.01 mass % and preferably not less than 0.20 mass %. On the other hand, if the ZrO₂ content is greater than 1.00 mass %, the arc strength increases, and therefore, under a high-current load, arc stability deteriorates, and the amount of spatter generated increases. Accordingly, the ZrO₂ content is not greater than 1.00 mass % and preferably not greater than 0.80 mass %.

### TiO₂: 0.01 Mass % or Greater and 0.50 Mass % or Less

TiO₂ is a component that produces effects of improving arc stability and, by serving as a slag-forming agent, improving the shape of the bead of the weld metal. If the TiO₂ content is less than 0.01 mass %, however, the effect of improving arc stability is not produced, and therefore, under a high-current load, arc stability deteriorates, and the amount of spatter generated increases. Accordingly, the TiO₂ content is not less than 0.01 mass % and preferably not less than 0.05 mass %. On the other hand, if the TiO₂ content is greater than 0.50 mass %, the droplet transfer becomes unstable, and therefore, under a high-current load, arc stability deteriorates, and the amount of spatter generated increases. Accordingly, the TiO₂ content is not greater than 0.50 mass % and preferably not greater than 0.30 mass %.

### NaF: 0.01 Mass % or Greater and 0.50 Mass % or Less

NaF is a component that produces an effect of sharpening the arc and improving arc stability. If the NaF content is less than 0.01 mass %, however, the effect of improving arc stability is not produced, and therefore, under a high-current load, arc stability deteriorates, and the amount of spatter generated increases. Accordingly, the NaF content is not less than 0.01 mass % and preferably not less than 0.05 mass %. On the other hand, if the NaF content is greater than 0.50 mass %, the arc strength increases, and therefore, under a high-current load, arc stability deteriorates, and the amount of spatter generated increases. Accordingly, the NaF content is not greater than 0.50 mass % and preferably not greater than 0.30 mass %.

### 1≤[ZrO₂]/[NaF]≤50

[ZrO₂]/[NaF] is an important index for ensuring that sufficient mechanical properties of the weld metal and good welding workability are both achieved. In the formula, [ZrO₂] is the content (mass %) of ZrO₂, and [NaF] is the content (mass %) of NaF. By making sure that the value calculated according to the formula is within the predetermined range, excellent welding workability under a high-current load, that is, high arc stability and a small amount of spatter generated, can be maintained. If the value calculated according to [ZrO₂]/[NaF] is less than 1, however, the arc strength increases, and therefore, under a high-current load, arc stability deteriorates, and the amount of spatter generated increases. Accordingly, the value calculated according to [ZrO₂]/[NaF] is not less than 1, preferably not less than 3, and more preferably not less than 5. On the other hand, if the value calculated according to [ZrO₂]/[NaF] is greater than 50, however, the arc length fluctuates, and therefore, under a high-current load, arc stability deteriorates, and the amount of spatter generated increases. Accordingly, the value calculated according to [ZrO₂]/[NaF] is not greater than 50, preferably not greater than 40, and more preferably not greater than 30.

The flux-cored wire according to the present embodiment may contain one or more optional components, examples of which include the following components (Al₂O₃, K₂O, and Na₂O).

Al₂O₃: 0.01 Mass % or Greater and 0.50 Mass % or Less

Al₂O₃ is a component that produces an effect of improving arc stability. If the Al₂O₃ content is less than 0.01 mass %, however, the effect of improving arc stability is not produced. Accordingly, when Al₂O₃ is included in the wire, the Al₂O₃ content is not less than 0.01 mass % and preferably not less than 0.02 mass %. On the other hand, if the Al₂O₃ content is greater than 0.50 mass %, an increased amount of oxygen is included in the weld metal, which results in a decrease in toughness. Accordingly, when Al₂O₃ is included in the wire, the Al₂O₃ content is not greater than 0.50 mass % and preferably not greater than 0.30 mass %.

### K₂O, in Terms of K: 0.01 Mass % or Greater and 0.50 Mass % or Less

K₂O is a component that produces an effect of improving arc stability. If the amount of K₂O in terms of K is less than 0.01 mass %, however, the effect of improving arc stability is not produced. Accordingly, when K₂O is included in the wire, the amount of K₂O in terms of K is not less than 0.01 mass % and preferably not less than 0.02 mass %. On the other hand, if the amount of K₂O in terms of K is greater than 0.50 mass %, an increased amount of oxygen is included in the weld metal, which results in a decrease in toughness. Accordingly, when K₂O is included in the wire, the content of K₂O is not greater than 0.50 mass % and preferably not greater than 0.30 mass %.

### Na₂O, in Terms of Na: 0.01 Mass % or Greater and 0.50 Mass % or Less

Na₂O is a component that produces an effect of improving arc stability. If the amount of Na₂O in terms of Na is less than 0.01 mass %, however, the effect of improving arc stability is not produced. Accordingly, when Na₂O is included in the wire, the amount of Na₂O in terms of Na is not less than 0.01 mass % and preferably not less than 0.02 mass %. On the other hand, if the amount of Na₂O in terms of Na is greater than 0.50 mass %, an increased amount of oxygen is included in the weld metal, which results in a decrease in toughness. Accordingly, when Na₂O is included in the wire, the content of Na₂O is not greater than 0.50 mass % and preferably not greater than 0.30 mass %.

### Balance

The balance of the flux-cored wire according to the present embodiment is Fe, mentioned above, and incidental impurities, for example. The flux-cored wire according to the present embodiment is a metallic flux-cored wire and may include, in the flux, the following components in small amounts, in addition to the wire components mentioned above, to the extent that the effects of the wire components mentioned above are not interfered with. Cr, Mo, and/or Cu, for example, may be included to serve as additional hardening agents for the weld metal. V₂O₅, for example, may be included to serve as a slag-forming agent. K₂SiF₆ and/or Na₃AlF₆, for example, may be included to serve as arc stabilizers. For example, Cr, Mo, Cu, and the like may be included, each in an amount less than 0.1 mass %, and V₂O₅ may be included in an amount less than 0.5 mass % Furthermore, for example, P, S, Sn, V, and the like, each in an amount not greater than 0.030 mass %, may be included.

### Others: Flux Filling Ratio

For the flux-cored wire according to the present embodiment, the flux filling ratio (=mass of flux/total mass of wire×100) is not particularly limited. If the flux filling ratio is less than 10 mass %, however, arc stability deteriorates and the amount of spatter generated increases, which degrades welding workability. Accordingly, the flux filling ratio is preferably not less than 10 mass % and more preferably not less than 14 mass %. On the other hand, if the flux filling ratio is greater than 25 mass %, productivity decreases because, for example, wire breakage occurs and/or, during the flux filling operation, the powder spills. Accordingly, the flux filling ratio is preferably not greater than 25 mass % and more preferably not greater than 20 mass %.

Next, a method for producing the flux-cored wire according to the present embodiment will be described.

### Method for Producing Wire

The method for producing the flux-cored wire according to the present embodiment is not particularly limited, but, for example, the flux-cored wire may be produced in accordance with the method described below. First, a steel strip that forms the steel sheath is provided. While being fed in the longitudinal direction, the steel strip is formed into a U-shaped open tube by using forming rolls. Next, a flux including various ingredients combined to form a predetermined chemical composition is placed to fill the interior of the steel sheath, and thereafter, the tube is processed to have a circular cross section. Subsequently, the tube is cold-drawn into a wire to form a flux-cored wire of 1.2 to 2.4 mm wire diameter, for example. Annealing may be performed during the process of cold drawing. The wire may be a seamless wire in which the seam of the steel sheath, which is formed during the production process, is welded, or the wire may be a wire in which the seam is not welded and the gap is therefore retained. Either of these structures may be employed.

The present invention will now be described in more detail with reference to invention examples and comparative examples; however, the present invention is not limited to these.

### Production of Flux-Cored Wire Used for Various Tests

While a steel strip was being fed in the longitudinal direction, the steel strip was formed into an open tube by using forming rolls. Subsequently, metals, alloys, Fe powder, and various ingredients were appropriately added to the flux, within predetermined ranges, so that each of the chemical compositions shown in Table 1 or Table 2 could be formed. Next, the tube was processed to have a circular cross section, and thereafter, the processed wire was subjected to cold wire drawing to a wire diameter of approximately 1.2 mm. Flux-cored wires were produced in accordance with the production method described above.

The content of each of the components shown in Table 1 or Table 2 is the content (mass %) relative to the total mass of the wire. In addition, in Table 1 or Table 2, SiO₂ denotes the amount in terms of Si, K₂O denotes the amount in terms of K, Na₂O denotes the amount in terms of Na, and [ZrO₂]/[NaF] denotes the ratio of [ZrO₂] to [NaF], where [ZrO₂] is the content (mass %) of ZrO₂, and [NaF] is the content (mass %) of NaF. In addition, Balance denotes Fe and incidental impurities. Furthermore, in Table 2, the symbol “-” indicates that the corresponding component was not actively added.

TABLE 1

| | Chemical composition of wire (mass %) | | | | | | | | | | | | | | |
|---|---|---|---|---|---|---|---|---|---|---|---|---|---|---|---|
| | | | | SiO₂ | | | | | | | | K₂O | Na₂O | | |
| Wire | | | Elemen- | (in terms | Total | Elemen- | Elemen- | | | | | (in terms | (in terms | [ZrO₂]/ | Bal- |
| No. | C | Mn | tal Si | of Si) | Si | tal Ti | tal Al | ZrO₂ | TiO₂ | NaF | Al₂O₃ | of K) | of Na) | [NaF] | ance ^{(Note 1)} |
| W1 | 0.10 | 2.7 | 0.5 | 0.21 | 0.71 | 0.31 | 0.08 | 0.12 | 0.15 | 0.07 | 0.04 | 0.05 | 0.04 | 1.7 | 96 |
| W2 | 0.01 | 2.5 | 0.5 | 0.37 | 0.87 | 0.14 | 0.09 | 0.17 | 0.20 | 0.13 | 0.01 | 0.11 | 0.08 | 1.3 | 96 |
| W3 | 0.02 | 4.0 | 0.6 | 0.55 | 1.15 | 0.29 | 0.10 | 0.23 | 0.18 | 0.03 | 0.02 | 0.02 | 0.08 | 7.7 | 94 |
| W4 | 0.02 | 1.5 | 0.5 | 0.25 | 0.75 | 0.10 | 0.09 | 0.48 | 0.07 | 0.04 | 0.08 | 0.10 | 0.14 | 12. | 97 |
| W5 | 0.02 | 1.9 | 2.0 | 0.47 | 2.47 | 0.28 | 0.14 | 0.17 | 0.06 | 0.08 | 0.01 | 0.07 | 0.19 | 2.1 | 95 |
| W6 | 0.02 | 2.3 | 0.1 | 0.64 | 0.74 | 0.35 | 0.19 | 0.26 | 0.20 | 0.01 | 0.13 | 0.05 | 0.18 | 26. | 96 |
| W7 | 0.02 | 2.3 | 0.9 | 0.68 | 1.58 | 1.00 | 0.17 | 0.24 | 0.05 | 0.14 | 0.02 | 0.02 | 0.13 | 1.7 | 94 |
| W8 | 0.03 | 2.6 | 1.2 | 0.10 | 1.30 | 0.01 | 0.08 | 0.13 | 0.05 | 0.12 | 0.10 | 0.08 | 0.22 | 1.1 | 95 |
| W9 | 0.02 | 2.1 | 0.9 | 0.09 | 0.99 | 0.25 | 1.00 | 0.19 | 0.11 | 0.13 | 0.11 | 0.15 | 0.13 | 1.5 | 95 |
| W10 | 0.03 | 2.4 | 1.2 | 0.39 | 1.59 | 0.15 | 0.01 | 0.23 | 0.16 | 0.09 | 0.03 | 0.14 | 0.07 | 2.6 | 95 |
| W11 | 0.03 | 2.4 | 1.0 | 0.42 | 1.42 | 0.10 | 0.15 | 1.00 | 0.10 | 0.09 | 0.07 | 0.01 | 0.08 | 11.1 | 95 |
| W12 | 0.02 | 2.9 | 1.1 | 0.42 | 1.52 | 0.12 | 0.12 | 0.01 | 0.08 | 0.01 | 0.12 | 0.12 | 0.02 | 1.0 | 95 |
| W13 | 0.02 | 2.7 | 0.8 | 1.00 | 1.80 | 0.35 | 0.05 | 0.43 | 0.12 | 0.03 | 0.13 | 0.06 | 0.12 | 14.3 | 94 |
| W14 | 0.02 | 2.8 | 0.7 | 0.01 | 0.71 | 0.13 | 0.08 | 0.33 | 0.07 | 0.03 | 0.10 | 0.04 | 0.10 | 11.0 | 96 |
| W15 | 0.02 | 2.6 | 1.0 | 0.45 | 1.45 | 0.10 | 0.16 | 0.40 | 0.50 | 0.06 | 0.02 | 0.11 | 0.21 | 6.7 | 94 |
| W16 | 0.03 | 2.2 | 1.2 | 0.45 | 1.65 | 0.35 | 0.10 | 0.16 | 0.01 | 0.07 | 0.03 | 0.01 | 0.03 | 2.3 | 95 |
| W17 | 0.03 | 2.4 | 0.7 | 0.54 | 1.24 | 0.37 | 0.15 | 0.67 | 0.08 | 0.50 | 0.11 | 0.03 | 0.01 | 1.3 | 94 |
| W18 | 0.02 | 2.8 | 0.9 | 0.55 | 1.45 | 0.39 | 0.14 | 0.48 | 0.06 | 0.01 | 0.06 | 0.02 | 0.08 | 48.0 | 95 |
| W19 | 0.03 | 2.8 | 0.6 | 0.05 | 0.65 | 0.26 | 0.08 | 0.35 | 0.07 | 0.03 | 0.50 | 0.02 | 0.02 | 11.7 | 95 |
| W20 | 0.02 | 2.8 | 0.8 | 0.07 | 0.87 | 0.21 | 0.15 | 0.59 | 0.01 | 0.07 | 0.01 | 0.01 | 0.08 | 8.4 | 95 |
| W21 | 0.03 | 2.8 | 1.2 | 0.31 | 1.51 | 0.10 | 0.14 | 0.21 | 0.09 | 0.08 | 0.07 | 0.50 | 0.10 | 2.6 | 94 |
| W22 | 0.03 | 2.1 | 1.2 | 0.35 | 1.55 | 0.21 | 0.14 | 0.21 | 0.12 | 0.06 | 0.03 | 0.01 | 0.07 | 3.5 | 95 |
| W23 | 0.03 | 2.3 | 0.7 | 0.40 | 1.10 | 0.27 | 0.06 | 0.20 | 0.15 | 0.13 | 0.06 | 0.07 | 0.50 | 1.5 | 95 |
| W24 | 0.02 | 2.5 | 1.0 | 0.52 | 1.52 | 0.37 | 0.17 | 0.44 | 0.18 | 0.18 | 0.11 | 0.05 | 0.01 | 2.4 | 94 |

^{(Note 1)}
Balance is Fe and incidental impurities.

TABLE 2

| | Chemical composition of wire (mass %) | | | | | | | | | | | | | | |
|---|---|---|---|---|---|---|---|---|---|---|---|---|---|---|---|
| | | | | SiO₂ | | | | | | | | K₂O | Na₂O | | |
| Wire | | | Elemen- | (in terms | Total | Elemen- | Elemen- | | | | | (in terms | (in terms | [ZrO₂]/ | Bal- |
| No. | C | Mn | tal Si | of Si) | Si | tal Ti | tal Al | ZrO₂ | TiO₂ | NaF | Al₂O₃ | of K) | of Na) | [NaF] | ance ^{(Note 2)} |
| W25 | 0.13 | 2.6 | 0.8 | 0.41 | 1.21 | 0.37 | 0.12 | 0.24 | 0.09 | 0.20 | 0.05 | 0.05 | 0.07 | 1.2 | 95 |
| W26 | 0.008 | 2.4 | 1.2 | 0.19 | 1.39 | 0.23 | 0.19 | 0.12 | 0.16 | 0.04 | 0.15 | 0.03 | 0.13 | 3.0 | 95 |
| W27 | 0.02 | 4.1 | 0.6 | 0.08 | 0.68 | 0.11 | 0.13 | 0.37 | 0.10 | 0.04 | 0.04 | 0.09 | 0.25 | 9.3 | 94 |
| W28 | 0.03 | 1.4 | 1.2 | 0.66 | 1.86 | 0.10 | 0.11 | 0.41 | 0.08 | 0.01 | 0.13 | 0.10 | 0.20 | 41.0 | 96 |
| W29 | 0.03 | 2.5 | 2.1 | 0.10 | 2.20 | 0.23 | 0.15 | 0.59 | 0.13 | 0.09 | 0.01 | 0.08 | 0.13 | 6.6 | 94 |
| W30 | 0.03 | 2.7 | 0.9 | 0.58 | 1.48 | 1.12 | 0.18 | 0.54 | 0.14 | 0.02 | 0.15 | 0.11 | 0.10 | 27.0 | 93 |
| W31 | 0.03 | 2.9 | 1.0 | 0.59 | 1.59 | — | 0.20 | 0.14 | 0.02 | 0.08 | 0.07 | 0.07 | 0.09 | 1.8 | 95 |
| W32 | 0.02 | 2.4 | 1.0 | 0.35 | 1.35 | 0.10 | 1.21 | 0.60 | 0.15 | 0.16 | 0.14 | 0.08 | 0.16 | 3.8 | 94 |
| W33 | 0.03 | 2.3 | 0.7 | 0.34 | 1.04 | 0.25 | — | 0.42 | 0.06 | 0.14 | 0.09 | 0.07 | 0.14 | 3.0 | 95 |
| W34 | 0.02 | 2.1 | 0.7 | 0.20 | 0.90 | 0.24 | 0.11 | 1.03 | 0.02 | 0.09 | 0.06 | 0.05 | 0.01 | 11.4 | 95 |
| W35 | 0.02 | 2.7 | 1.0 | 0.59 | 1.59 | 0.14 | 0.09 | — | 0.20 | 0.01 | 0.13 | 0.12 | 0.02 | — | 95 |
| W36 | 0.02 | 2.3 | 0.8 | 0.33 | 1.13 | 0.22 | 0.20 | 0.38 | 0.53 | 0.16 | 0.02 | 0.12 | 0.01 | 2.4 | 95 |
| W37 | 0.03 | 2.0 | 0.9 | 0.08 | 0.98 | 0.22 | 0.17 | 0.18 | — | 0.16 | 0.03 | 0.04 | 0.13 | 1.1 | 96 |
| W38 | 0.02 | 2.5 | 0.7 | 0.41 | 1.11 | 0.33 | 0.12 | 0.59 | 0.11 | 0.54 | 0.08 | 0.09 | 0.16 | 1.1 | 94 |
| W39 | 0.02 | 2.0 | 1.0 | 0.14 | 1.14 | 0.30 | 0.17 | 0.17 | 0.05 | — | 0.06 | 0.17 | 0.15 | 24.3 | 96 |
| W40 | 0.02 | 2.3 | 0.9 | 0.57 | 1.47 | 0.36 | 0.18 | 0.87 | 0.11 | 0.01 | 0.05 | 0.12 | 0.14 | 87.0 | 94 |
| W41 | 0.03 | 2.7 | 1.3 | 0.44 | 1.74 | 0.28 | 0.07 | 0.39 | 0.13 | 0.47 | 0.17 | 0.06 | 0.21 | 0.8 | 94 |

^{(Note 2)}
Balance is Fe and incidental impurities.

### Evaluation of Welding Workability

### Welding Conditions

To evaluate welding workability, gas shielded arc welding was performed with each of the flux-cored wires under the conditions shown in Table 4, with a steel sheet having a chemical composition as shown in Table 3 used as the base metal. The balance of the chemical composition of the steel sheet shown in Table 3 is Fe and incidental impurities.

TABLE 3

| Chemical composition of base metal (mass %) ^{(Note 3)} | | | | | | Thickness |
|---|---|---|---|---|---|---|
| | C | Si | Mn | P | S | (mm) |
| JIS G 3106: | 0.14 | 0.20 | 1.10 | 0.015 | 0.005 | 25 |
| 2015 SM490A | | | | | | |

^{(Note 3)}
Balance is Fe and incidental impurities.

TABLE 4

| | |
|---|---|
| Welding current | 280 A |
| Welding voltage | 34 V |
| Welding power supply and | Thyristor power supply with |
| polarity | current rating of 350 A, DCEP |
| Welding position | Downward welding |
| Type of shielding gas | 100 vol % CO₂ |
| Flow rate of shielding gas | 25 L/min |
| Interpass temperature | 150° C. ± 15° C. |
| Heat input | 30 KJ/cm |
| Wire diameter | 1.2 mm |
| Wire extension | 25 mm |

### Arc Stability

With regard to arc stability, gas shielded arc welding was performed similarly to the above with each of the flux-cored wires under the conditions shown in Table 4, with a steel sheet having a chemical composition as shown in Table 3 used as the base metal. Evaluations were made by sensory evaluation. The symbol “◯” indicates that the arc was determined to be stable, and the symbol “x” indicates that the arc was determined to be unstable. For arc stability, specimens rated as “◯” were determined to be “pass”, and specimens rated as “x” were determined to be “fail”.

### Amount of Spatter Generated

With regard to the amount of spatter generated, gas shielded arc welding was performed similarly to the above with each of the flux-cored wires of the invention examples and the comparative examples under the conditions shown in Table 4, with a steel sheet having a chemical composition as shown in Table 3 used as the base metal, and evaluations were made quantitatively based on the amount of spatter generated during the welding test. Specifically, in accordance with WES 2807: 2000, welding was performed in an environment in which a collection chamber for ensuring collection of spatter was provided. The arc time was 60 seconds, and after completion of welding, spatter was collected from the collection chamber and the weight was measured. This operation was repeated twice, and the amount of spatter generated was determined as the average. In each of the invention examples and the comparative examples, specimens having an amount of spatter generated of less than 2 g/min were rated as “◯, and specimens having an amount of spatter generated of 2 g/min or more were rated as “x”. In the tables, the symbol “◯” indicates “pass”, and the symbol “x” indicates “fail”.

### Evaluation of Mechanical Properties of Weld Metal

### Welding Conditions

In evaluation of the mechanical properties of the weld metal, gas shielded arc welding was also performed under conditions similar to those used in the evaluation of welding workability.

### Mechanical Properties

The mechanical properties of the weld metal were evaluated by conducting a tensile test and an impact test in accordance with “Methods of tension and impact tests for deposited metal”, which is specified in JIS Z 3111:2006. The tensile specimen used was a No. A0 specimen, which was cut from a middle position in the thickness direction in a middle region of the weld metal. The impact specimen used was a V-notch specimen, which was cut from a middle position in the thickness direction in a middle region of the weld metal.

With regard to tensile strength (TS), specimens that had a tensile strength of 490 to 670 MPa were rated as “◯”, and specimens that had a tensile strength of less than 490 MPa or a tensile strength of greater than 670 MPa were rated as “x”. With regard to toughness (vE_{0° C.}), specimens that had an absorbed energy at 0° C. of 70 J or greater were rated as “⊙”, specimens that had an absorbed energy at 0° C. of 47 J or greater and less than 70 J were rated as “◯”, and specimens that had an absorbed energy at 0° C. of less than 47 J were rated as “x”.

Table 5 and Table 6, presented below, show the results of the various tests described above.

TABLE 5

| | | Welding workability | | Mechanical properties | | | |
|---|---|---|---|---|---|---|---|
| | | | Amount of | Tensile | | Toughness | |
| Test | Wire | Arc | spatter | strength (TS) | | (vE_{0° C.}) | |
| No. | No. | stability | generated | MPa | Rating | J | Rating |
| 1 | W1 | ◯ | ◯ | 609 | ◯ | 58 | ◯ |
| 2 | W2 | ◯ | ◯ | 581 | ◯ | 66 | ◯ |
| 3 | W3 | ◯ | ◯ | 628 | ◯ | 72 | ⊙ |
| 4 | W4 | ◯ | ◯ | 563 | ◯ | 61 | ◯ |
| 5 | W5 | ◯ | ◯ | 577 | ◯ | 65 | ◯ |
| 6 | W6 | ◯ | ◯ | 579 | ◯ | 54 | ◯ |
| 7 | W7 | ◯ | ◯ | 627 | ◯ | 60 | ◯ |
| 8 | W8 | ◯ | ◯ | 590 | ◯ | 66 | ◯ |
| 9 | W9 | ◯ | ◯ | 594 | ◯ | 62 | ◯ |
| 10 | W10 | ◯ | ◯ | 584 | ◯ | 73 | ⊙ |
| 11 | W11 | ◯ | ◯ | 584 | ◯ | 68 | ◯ |
| 12 | W12 | ◯ | ◯ | 615 | ◯ | 70 | ⊙ |
| 13 | W13 | ◯ | ◯ | 608 | ◯ | 69 | ◯ |
| 14 | W14 | ◯ | ◯ | 600 | ◯ | 64 | ◯ |
| 15 | W15 | ◯ | ◯ | 611 | ◯ | 60 | ◯ |
| 16 | W16 | ◯ | ◯ | 582 | ◯ | 55 | ◯ |
| 17 | W17 | ◯ | ◯ | 574 | ◯ | 57 | ◯ |
| 18 | W18 | ◯ | ◯ | 622 | ◯ | 65 | ◯ |
| 19 | W19 | ◯ | ◯ | 597 | ◯ | 57 | ◯ |
| 20 | W20 | ◯ | ◯ | 619 | ◯ | 72 | ⊙ |
| 21 | W21 | ◯ | ◯ | 627 | ◯ | 64 | ◯ |
| 22 | W22 | ◯ | ◯ | 585 | ◯ | 62 | ◯ |
| 23 | W23 | ◯ | ◯ | 580 | ◯ | 60 | ◯ |
| 24 | W24 | ◯ | ◯ | 602 | ◯ | 62 | ◯ |

TABLE 6

| | | Welding workability | | Mechanical properties | | | |
|---|---|---|---|---|---|---|---|
| | | | Amount of | Tensile | | Toughness | |
| Test | Wire | Arc | spatter | strength (TS) | | (vE_{0° C.}) | |
| No. | No. | stability | generated | MPa | Rating | J | Rating |
| 25 | W25 | ◯ | X | 620 | ◯ | 61 | ◯ |
| 26 | W26 | ◯ | ◯ | 580 | ◯ | 45 | X |
| 27 | W27 | ◯ | ◯ | 680 | X | 74 | ⊙ |
| 28 | W28 | ◯ | ◯ | 470 | X | 64 | ◯ |
| 29 | W29 | ◯ | ◯ | 671 | X | 66 | ◯ |
| 30 | W30 | ◯ | ◯ | 674 | X | 53 | ◯ |
| 31 | W31 | X | X | 572 | ◯ | 49 | ◯ |
| 32 | W32 | ◯ | ◯ | 607 | ◯ | 39 | X |
| 33 | W33 | X | X | 574 | ◯ | 68 | ◯ |
| 34 | W34 | X | X | 589 | ◯ | 66 | ◯ |
| 35 | W35 | X | X | 620 | ◯ | 71 | ⊙ |
| 36 | W36 | X | X | 617 | ◯ | 57 | ◯ |
| 37 | W37 | X | X | 574 | ◯ | 64 | ◯ |
| 38 | W38 | X | X | 602 | ◯ | 69 | ◯ |
| 39 | W39 | X | X | 584 | ◯ | 62 | ◯ |
| 40 | W40 | X | X | 590 | ◯ | 67 | ◯ |
| 41 | W41 | X | X | 588 | ◯ | 60 | ◯ |

As shown in Table 5, in each of Test Nos. 1 to 24, in which invention example wires, Nos. W1 to W24, were respectively used, arc stability was high and the amount of spatter generated was small in high heat input welding. It is therefore apparent that Wires Nos. 1 to 24 afford excellent welding workability for high heat input welding. In addition, the resulting weld metal had both excellent tensile strength (TS) and excellent toughness (vE_{0° C.}), which indicates that weld metal having good mechanical properties can be obtained. Note that, in the present invention, “high heat input welding” is welding with a heat input of, for example, 30 kJ/cm or greater.

On the other hand, as shown in Table 6, in each of Test Nos. 25 to 41, in which comparative example wires, Nos. W25 to W41, were respectively used, the result of “Pass” was not obtained for one or more evaluation categories. Specifically, the results were as follows.

For example, in Test No. 34 (Wire No. W34), the ZrO₂ content in the wire was greater than the upper limit, and as a result, arc stability was degraded and the amount of spatter generated increased, which indicates poor welding workability. In Test No. 35 (Wire No. W35), the ZrO₂ content in the wire was less than the lower limit, and as a result, arc stability was degraded and the amount of spatter generated increased, which indicates poor welding workability. In Test No. 38 (Wire No. W38), the NaF content in the wire was greater than the upper limit, and as a result, arc stability was degraded and the amount of spatter generated increased, which indicates poor welding workability. In Test No. 39 (Wire No. W39), the NaF content in the wire was less than the lower limit, and as a result, arc stability was degraded and the amount of spatter generated increased, which indicates poor welding workability. In Test No. 40 (Wire No. W40), the value calculated according to [ZrO₂]/[NaF] of the wire was greater than the upper limit, and as a result, arc stability was degraded and the amount of spatter generated increased, which indicates poor welding workability. In Test No. 41 (Wire No. W41), the value calculated according to [ZrO₂]/[NaF] of the wire was less than the lower limit, and as a result, arc stability was degraded and the amount of spatter generated increased, which indicates poor welding workability.

The above description describes the present invention in detail on the basis of the specific examples provided above. However, the present invention is not limited to the specific examples provided above, and various modifications and changes may be made without departing from the scope of the present invention.

What is claimed is:

1. A flux-cored wire for gas shielded arc welding, the flux-cored wire including a steel sheath filled with a flux, the flux-cored wire comprising, relative to the total mass of the wire,
C: 0.01 mass % or greater and 0.10 mass % or less,
Mn: 1.5 mass % or greater and 4.0 mass % or less,
Si: 0.1 mass % or greater and 2.5 mass % or less,
elemental Ti: 0.01 mass % or greater and 1.00 mass % or less,
elemental Al: 0.01 mass % or greater and 1.00 mass % or less,
Fe: 90 mass % or greater,
ZrO₂: 0.01 mass % or greater and 1.00 mass % or less,
TiO₂: 0.01 mass % or greater and 0.50 mass % or less, and
NaF: 0.01 mass % or greater and 0.50 mass % or less,
wherein 1≤[ZrO₂]/[NaF]≤50 is satisfied, where [ZrO₂] is a ZrO₂ content, and [NaF] is a NaF content.

2. The flux-cored wire for gas shielded arc welding according to claim 1, further comprising, relative to the total mass of the wire,
Al₂O₃: 0.01 mass % or greater and 0.50 mass % or less.

3. The flux-cored wire for gas shielded arc welding according to claim 1, further comprising, relative to the total mass of the wire, at least one of
K₂O, in terms of K: 0.01 mass % or greater and 0.50 mass % or less, and
Na₂O, in terms of Na: 0.01 mass % or greater and 0.50 mass % or less.

4. The flux-cored wire for gas shielded arc welding according to claim 2, further comprising, relative to the total mass of the wire, at least one of
K₂O, in terms of K: 0.01 mass % or greater and 0.50 mass % or less, and
Na₂O, in terms of Na: 0.01 mass % or greater and 0.50 mass % or less.
